(19) United States
(12) Patent Application Publication
(10) Pub. No.: US 2014/0127080 A1
(43) Pub. Date: May 8, 2014

(54) DISTRIBUTED OZONE DISINFECTION SYSTEM

(71) Applicants: Larry LaVerne, Tarzana, CA (US); Tony Dugo, Tarzana, CA (US)

(72) Inventors: Larry LaVerne, Tarzana, CA (US); Tony Dugo, Tarzana, CA (US)

(73) Assignee: Eco-Safe Systems USA, Inc., Tarzana, CA (US)

(21) Appl. No.: 13/854,884

(22) Filed: Apr. 1, 2013

Related U.S. Application Data
(60) Provisional application No. 61/618,552, filed on Mar. 30, 2012.

(51) Int. Cl. B01J 19/08

(52) U.S. Cl. CPC B01J 19/088
USPC 422/111; 422/186.05

(57) ABSTRACT

Systems and methods that facilitate aqueous ozone disinfection on a distributed basis that is sufficient to be effective at dramatically reducing bacteria on materials washed with ozonated water. The system provided herein facilitates the distribution of ozonated water to multiple sinks while keeping the additional hardware and associated costs at each sink at a minimum.

### CROSS-REFERENCE TO RELATED APPLICAITONS

This application claims the benefit of U.S. Provisional application No. 61/618,552, filed Mar. 30, 2012, which application is incorporated by reference.

### FIELD

The embodiments described herein relate generally to ozone disinfection and, more particularly, to systems and methods that facilitate aqueous ozone disinfection on a distributed basis that is sufficient to be effective at dramatically reducing bacteria on materials washed with ozonated water.

### BACKGROUND INFORMATION

The current accepted practice in food preparation typically results in the bacteria that arrived on the food item being spread to the prepared portions of the food item or to other items. The bacteria can lead to food spoilage and other complications resulting in increased costs.

In order to combat the spread of bacteria, most establishments rinse the food items with water upon arrival and also rinse the food preparation surfaces and tools with water throughout the day. Water alone does not eliminate the bacteria. However, ozone in water has been demonstrated to be effective at dramatically reducing bacteria on materials washed with that ozonated water.

In a food preparation installation, such as a restaurant or food packaging facility, an ozonated water system typically includes one or more sinks with a separate ozone generation system coupled to separate ones of the one or more sinks to supply ozonated water from the one or more sinks. In installations with several sinks, supplying ozonated water from each sink can be costly. In addition, in may not be physically feasible due to space and/or aesthetic reasons to provide an ozone generation system at each sink.

Thus, it is desirable to provide a distributed ozone system that would facilitate aqueous ozone disinfection on a distributed basis that is sufficient to be effective at dramatically reducing bacteria on materials washed with ozonated water.

### SUMMARY

The embodiments described herein are directed to systems and methods that would facilitate aqueous ozone disinfection on a distributed basis that is sufficient to be effective at dramatically reducing bacteria on materials washed with ozonated water. The system provided herein facilitates the distribution of ozonated water to multiple sinks while keeping the additional hardware and associated costs at each sink at a minimum. In one embodiment, water supplied to a sink is mixed with ozone to produce ozonated water. The system includes a central ozone generation system coupled to a venturi system at each sink. The venturi system is used to mix the ozone with the water. The level of ozonation of the water at each sink may be monitored in real-time by an Oxidation-Reduction-Potential (ORP) meter to verify that the ozone level at each sink is sufficient to disinfect any pathogens present. A flow switch is positioned in line after the venturi system and coupled to the ozone generation system to prevent production of ozone until after the flow of water has commenced through the venturi system.

Other systems, methods, features and advantages of the example embodiments will be or will become apparent to one with skill in the art upon examination of the following figures and detailed description.

### BRIEF DESCRIPTION OF THE FIGURES

The details of the example embodiments, including structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic diagram of a distributed ozone disinfection system.

FIG. 2 is a flow diagram of a distributed ozone disinfection system.

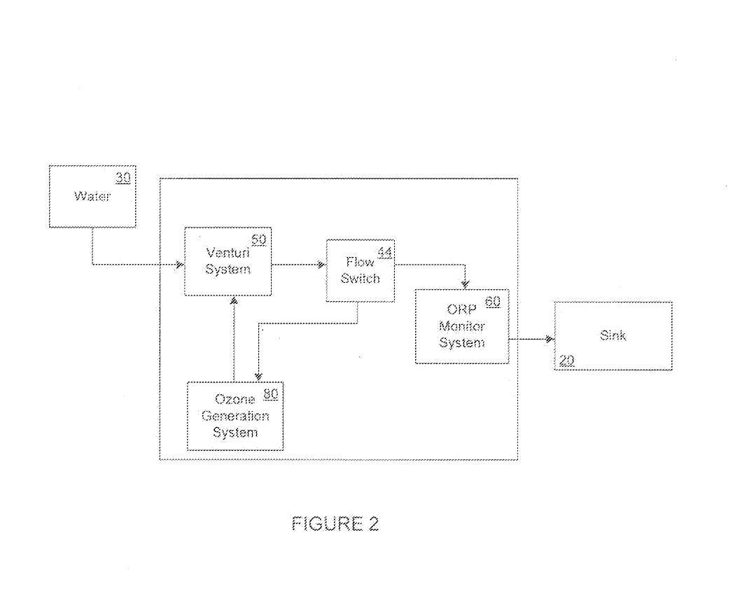

FIG. 3 is a front view of a gas injector venturi device.

FIG. 4 is a schematic of a control diagram for control of the distributed ozone disinfection system.

FIG. 5 is a plan view of an ozone generator system.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Each of the additional features and teachings disclosed below can be utilized separately or in conjunction with other features and teachings to produce systems and methods to facilitate distributed aqueous ozone disinfection. Representative examples of the present invention, which utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

The systems and methods provided herein address distribution of ozonated water to multiple sinks while keeping the additional hardware and associated costs at each sink at a minimum. The present systems and methods also allow the user to verify that the ozone level at each sink is sufficient to disinfect any pathogens present. The present system is particularly suited to use in restaurants and markets for ensuring the freshness and safety of food.

To keep the added hardware at each sink at a minimum and the price per cost low, the ozone is generated at a central location in the facility and piped through tubes to a plurality of sinks. In a preferred embodiment, up to six sinks are preferably supplied with ozone from a single ozone generation system at a distance of up to 50 feet from the location where the ozone is generated. Just before the cold water pipe enters the sink the water pipe and the ozone tube are connected via a venturi device that mixes the ozone into the water. At the output of the venturi device is an optional oxidation reduction potential (ORP) sensor that measures the level of ozone in the water. If the ozone level is appropriate for pathogen reduction, the sensor will cause a light to go on near the sink so that a user can be sure that sufficient ozone is being generated.

In order that ozone is generated only when it is needed, a thermal differential flow switch attached to the water pipe near the sink is used to determine when cold water is flowing into the sink. A wire connects this switch to the central ozone generating device. When the device detects water flowing into the sink, it signals the ozone generating device to begin generating ozone. Approximately half a gallon of water will flow into the sink before the ozone reaches the sink. This will vary depending on the flow rate of the water.

To produce the-ozone gas the centralized device consists of a pump that pushes ambient air into the device, a dehumidifier to ensure that the dew point of the pumped in air is sufficiently low for the ozone generator to work effectively, and an ozone generator that uses the corona discharge method for producing ozone. A fan is included to ensure that the device does not overheat.

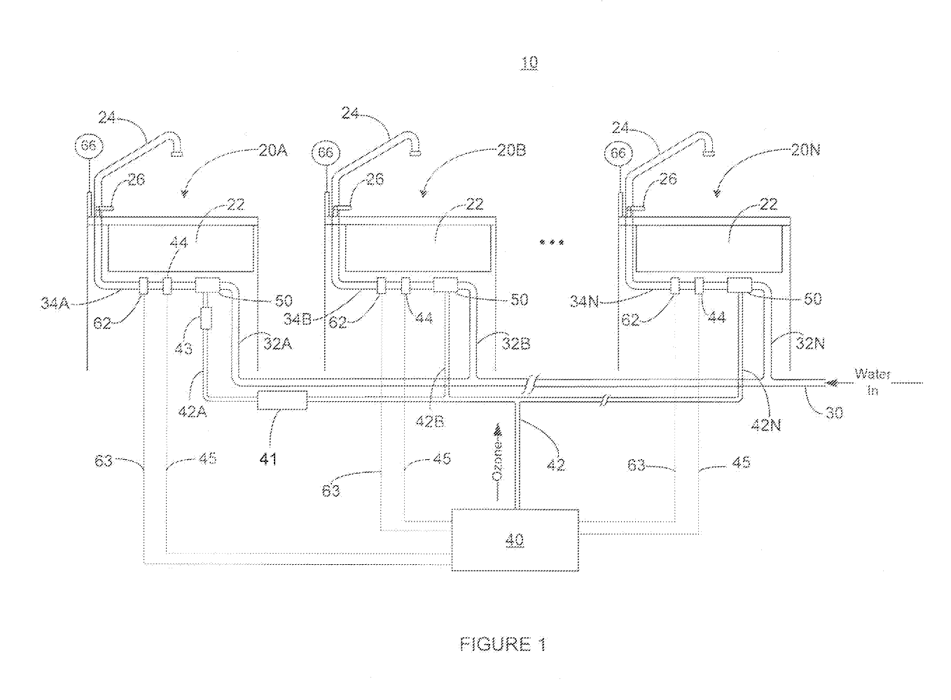

A system 10, as shown in FIG. 1, for disinfection of pathogen on food items and other materials and tools encountered during food preparation and packaging in restaurants and markets, and the like, is comprised of a plurality of N sinks 20A, 20B and 20N coupled to a water supply line 30. Each sink includes a basin 22, a faucet, and an on-off valve 26. The water supply line 30 branches off to each sink 20A, 20B and 20N at supply branches 32A, 32B and 32N. Each supply branch includes a venturi system 50 where the water is mixed with ozone from a central ozone generating system 40 to produce ozonated water. The venturi systems 50 are coupled to the central ozone generating system 40 via ozone supply tubing 42 which branches off at branches 42A, 42B and 42N to supply ozone to each venturi system 50. A flow switch 44 is positioned downstream of the venturi system 50 and coupled to the central ozone generating system 40 electrically along line 45 or wirelessly. Alternatively, a flow switch may instead be positioned upstream of the supply branches 32A, 32B and 32N in the water supply line 30 to detect flow through any of the supply branches 32A, 32B and 32N. An ORP sensor 62 of an ORP monitoring system 60 is also positioned downstream of the venturi system 50 and may be coupled to the central ozone generating system 40 electrically along line 63 or wirelessly.

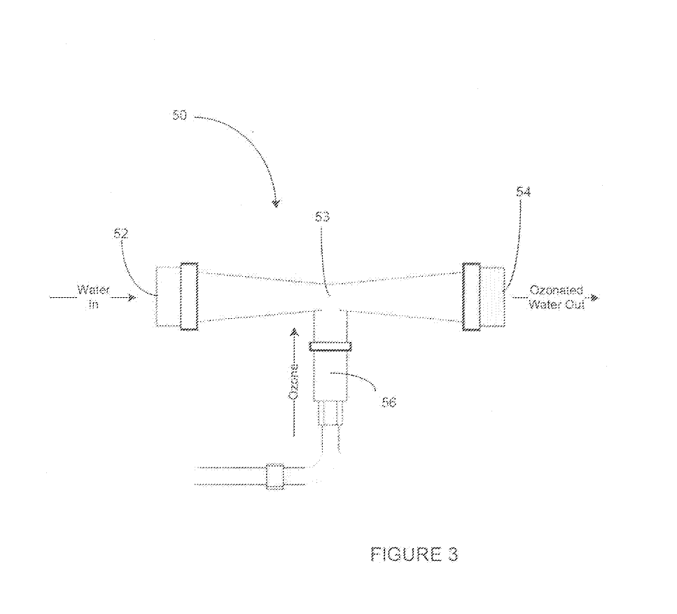

In another alternative, an ozone reservoir 41 may be positioned downstream of the central ozone generating system 40 in one or more of the supply branches 32A, 32B and 32N prior to the venture system 50. The ozone reservoir tends to speed up the process of ozonating the water. The reservoir 41 is desirable for sinks that are spaced at a significant distance from the ozone generator system 40. A one way check valve 43 is positioned upstream of the reservoir 41 prior to the venture system 50 to prevent water from flowing into the gas line 42A. The venturi system 50 is preferably a gas injector venturi device, such as a Mazzei® venturi-type, differential pressure injector. See, e.g., U.S. Pat. No. 5,863,128. As depicted in greater detail in FIG. 3, the gas injector venturi device 50 narrows as it transitions from an injector inlet 52 to an injection chamber 53 and then widens as the injector 50 transitions from the injection chamber 53 to an injector outlet 54. Located at the injection chamber 53 is a gas injection port 56. An ozone gas supply line 42 (FIG. 1), which extends to each sink, is coupled to the injection port 56. Pressurized water entering the inlet 52 of the injector 50 changes to a high velocity jet stream as it passes through the injection chamber 53 drawing the ozone gas in through the injection port 56 to be entrained or dissolved in the pressurized water.

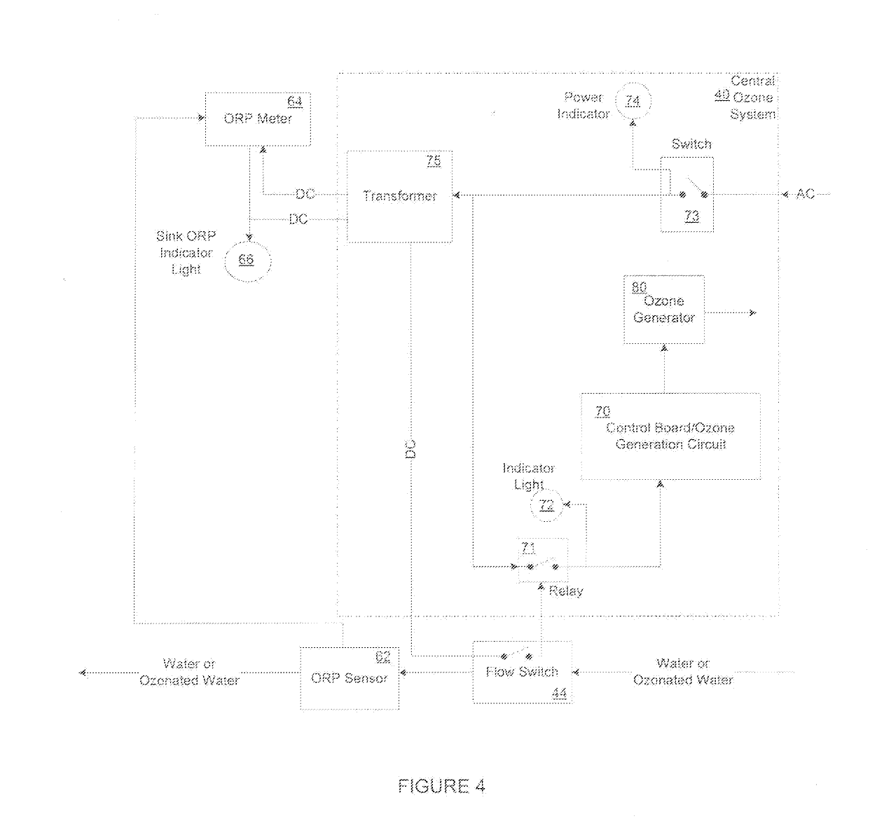

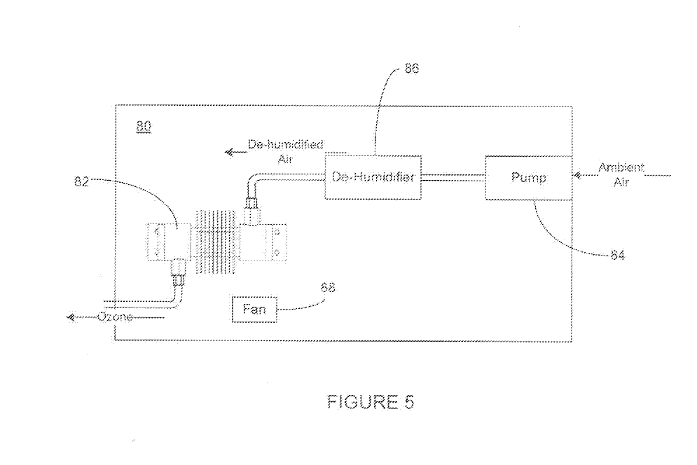

Referring to FIGS. 1 and 4, the ozonated water exits the venturi device 50 and continues through an ozonated water piping section 34A, 34B and 34N at each sink. An Oxidation-Reduction Potential (ORP) monitor system 60 includes a sensor 62 positioned downstream of the venturi device 50. The ORP sensor 62 includes a probe extending into the flow of ozonated water in the ozonated water piping section 34A, 34B and 34N. An ORP meter 64 analyzes the data from the ORP sensor 62 to determine if the level of ozone in the water is at a level sufficient for pathogen reduction. If so, the ORP meter 64 will cause an ORP indicator light 66 to go on at or near the sink so as to indicate to the user that sufficient ozone is being generated. As depicted in FIGS. 4 and 5, the central ozone generating system 40 includes an ozone generation system 80 that includes an ozone generator 82 having an inlet and outlet. The ozone generator 82 is preferably a corona discharge type ozone generator. The ozone generator 82 is coupled at its inlet to an air pump 84 and a de-humidifier 86. The central ozone generating system 40 includes a control board 70 coupled to the ozone generation system 80 and configured to control the operation of the generation system 80.

The control logic for the central ozone generating system 40 is depicted in FIG. 4. As depicted, AC power at 120 V, 60 Hz is supplied to the system 40 and a user controlled mechanical switch 73 for interruptng power to the system 40 is provided. Included in the switch 73 is a power indicator light 74. An AC-to-DC power transformer 75 is coupled to the switch 73 and provides 24 V DC power to the ORP (oxidation reduction potential) meter 64, an ORP indicator light 66, and a transfer relay 71. As depicted, when the flow switch 44 detects water flowing, it closes a DC circuit that in turn closes (activations) the transfer relay 71, giving AC power to the ozone generation circuit 70 and the ozone generator 80. The ozone control board/generation circuit 70 and ozone generation system 80 are coupled in series with the transfer relay 71 to generate ozone once the relay 71 is activated to power the ozone generation circuit 70. An indicator light 72 connected to the relay 71 indicates whether ozone is being generated (green) or not (red) based on whether the transfer relay is open (red) or closed (green).

In operation, pressurized water is supplied to the system so that water is flowing past the flow switch 44. When the power switch 73 is turned on or closed, the flow switch 44 senses whether water is flowing through the venturi system 50 for ozone to be mixed with. If water flow is detected by the flow switch 44, the flow switch activates the transfer relay 71. As a result, the transfer relay 71 closes and powers the ozone generation circuit 70 which causes the ozone generator 82 to generate ozone. With the transfer relay 71 activated, the indicator light 72 is illuminated green. If the flow switch 44 does not detect water flow through the piping system, the flow switch 44 will not activate the transfer relay 71 and, thus, the ozone generation circuit 70 will not be powered to cause the ozone generator 82 to generate ozone. With the transfer relay 71 remaining open, the indicator light 72 is illuminated red.

Alternatively, instead of a flow switch, a vacuum sensor is provided to sense a vacuum at the gas injection port 56 of the gas injector venturi device 50 as water flows through the gas injector venturi device 50.

The example embodiments provided herein, however, are merely intended as illustrative examples and not to be limiting in any way. Moreover, one skilled in the art will readily recognize that similar systems can be equally adapted with appropriate modification of parameters.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A distributed ozone disinfect ion system comprising a central ozone generation system,
a plurality of ozone and water mixing systems, each of the plurality of ozone and water mixing systems positionable in a water supply piping at a water supply inlet for a sink,
a plurality of flow switches, separate ones of the plurality of flow switches positionable downstream of separate ones of the plurality of ozone and water mixing systems, and
a plurality of oxidation reduction potentiometers (ORPs), separate ones of the plurality of ORPs positionable downstream of separate ones of the plurality ozone and water mixing systems.

2. The system of claim 1 wherein the ozone and water mixing system includes a gas injection venturi device.

3. The system of claim 1 wherein the ozone generation system includes an ozone generator, wherein the ozone generator is a corona discharge type ozone generator.

4. The system of claim 1 further comprising a control system coupled to the ozone generation system.

5. The system of claim 4 wherein the control system includes a transfer relay and a flow switch to activate the transfer relay upon sensing of sufficient water flow through the flow switch, activation of the transfer relay powers the ozone generation system.

6. The system of claim 5 wherein separate ones of the plurality of ORP meters are electrically coupled to an indicator light at the sink that indicates to the user of the sink that the ORP is high enough to effectively reduce the bacteria in the food washed by the ozonated water.

7. The system of claim 1 further comprising an ozone reservoir positioned downstream of the ozone generation system adjacent one of the plurality of ozone and water mixing systems.

8. The system of claim 7 further comprising a one way check valve positioned between the ozone reservoir and the one of the plurality of ozone and water mixing systems.
